(19) United States
(12) Patent Application Publication
(10) Pub. No.: US 2008/0052345 A1
(43) Pub. Date: Feb. 28, 2008

(54) Data displays utilizing peer-to-peer communications in a measurement system

(76) Inventors: John C. Eidson, Palo Alto, CA (US); Daniel Lee Pleasant, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/511,931

(22) Filed: Aug. 28, 2006

(51) Int. Cl. G06F 15/16; G09G 5/00

(52) U.S. Cl. 709/203; 345/204; 709/201

(57) ABSTRACT

A synthetic instrument having a local area network, a plurality of component modules and a data source module is disclosed. Each component module has an input for receiving an input signal, an output for transferring an output signal derived from the input signal by that component module, and a network port that connects that module to the local area network. One of the component modules receives a signal that is external to the instrument for processing on that component module's input port. The data source module generates data that can be displayed. The data source module is connected to the local area network and broadcasts the data on the network. The data includes information identifying the data. The instrument may also include a display module connected to the local area network, the display module displaying the data on a display connected to the display module.

### BACKGROUND OF THE INVENTION

Test instruments were originally compact stand-alone devices that performed physical measurements and displayed the results. For example, an oscilloscope measured the voltage as a function of time at a particular point in a circuit and displayed the result as a simple graph of voltage versus time. As the cost of computational hardware decreased, additional capabilities were incorporated into test instruments to provide increased computational and display capabilities. This new class of instruments typically included a general-purpose computer that performed various calculations on the raw data and provided more sophisticated data output capabilities including enhanced displays.

A new class of test instruments that are often referred to as “synthetic instruments” have provided additional benefits. A synthetic instrument is constructed from a number of component modules to provide a measurement and display that cannot be carried out by any one of the modules alone. For example, a frequency analyzer can be constructed from a down sampling module that shifts the input signal to an intermediate frequency by mixing the input signal with a local oscillator, a sweep generator that provides the local oscillator frequency, an analog-to-digital converter that measures the amplitude or power of the intermediate frequency signal, and a controller that displays the data and controls the sweep generator. The various component modules communicate with the controller and each other. This arrangement provides advantages over a conventional test instrument in that the component modules can be utilized in a number of different instruments. In addition, modules from different manufacturers can be more conveniently incorporated in a test instrument from yet another manufacturer.

However, to a user, a synthetic instrument still appears to be a conventional test instrument that has a display function that is provided by an internal controller. Typically, a change in the display function requires the cooperation of the manufacturer and the production of a new version of the instrument software. Since the manufacturer must support the new system, the manufacturer may be hesitant to provide different display options unless the new options are likely to be of interest to a significant number of customers.

Further, if the user wishes to have the data displayed at a remote location in a format that is customized to that location, the internal controller must be reprogrammed to provide the data to the remote display computer either in the new format or in a raw format that is used by the remote display program to generate the new display. Hence, even if the manufacturer is willing to provide the alterations needed to send the raw data to the remote location, the user must provide the display computer and display software together with the software needed to transfer the raw data to the remote display computer. This requires considerable development time and cost to the user. In addition, the development of proprietary display programs for which the user is charged additional fees are inhibited, since the capability must be integrated into the central controller, and hence, require the cooperation of the instrument manufacturer and a significant design time to implement.

### SUMMARY OF THE INVENTION

The present invention includes a synthetic instrument having a local area network, a plurality of component modules and a data source module. Each component module has an input for receiving an input signal, an output for transferring an output signal derived from the input signal by that component module, and a network port that connects that module to the local area network. One of the component modules receives a signal that is external to the instrument for processing on that component module's input port. The data source module generates data that can be displayed. The data source module is connected to the local area network and broadcasts the data on the network. The data includes information identifying the data. The instrument may also include a display module connected to the local area network, the display module displaying the data on a display connected to the display module. The instrument may also include an external network interface for coupling the local area network to a network external to the instrument, the external network interface broadcasting the data on the external network. The display may include a default display that displays the data in a standard format that depends on the identifying information. The data source module may broadcast the data on the network in a plurality of data messages, each data message is in a different data format. One of these messages may be encrypted such that only a subset of the display modules connected to the instrument can display the data in that message.

### BRIEF DESCRIPTION OF THE DRAWING

FIG. 1 illustrates a spectrum analyzer utilizing a display system according to one embodiment of the present invention.

### DETAILED DESCRIPTION OF EMBODIMENTS OF THE INVENTION

For the purposes of the present discussion, a synthetic instrument will be defined to be an instrument that processes an instrument input signal to arrive at an instrument output by applying a plurality of component modules to the input signal or signals derived therefrom. Each component module has a component input and a component output. The instrument input signal is applied to the component input of one of the component modules. The output of that component module can form the input of another component module and so on. The synthetic instrument can also include component modules that provide other inputs to one or more of the other component modules. In addition, the output of one or more of the modules could be a visual display. Finally, it should be noted that a component module could have a plurality of inputs and outputs, and these inputs and outputs could be digital, analog, or a combination of both digital and analog.

The sequence of input and output signals discussed above will be referred to as the signal path in the following discussion. This path can be a linear path consisting of the nodes between the component modules or a branched path. In addition to this signal path, the synthetic instrument includes a local network that connects some or all of the component modules. This network is used to communicate information that is generated by, or to be used by, one or more of the component modules.

In a synthetic instrument according to the present invention, at least one of the component modules generates data that could be displayed. This module will be referred to as a data source module in the following discussion. There may be more than one such module in an instrument. Each data source module broadcasts the data on the network together with information describing the data when the data is ready for display. Any component module on the network, or on another network connected to the internal network, can receive the data and display it or provide other forms of data processing. The information broadcast by the data source module includes information that will allow a receiving module to identify the data, and hence, provide at least one display mode if that receiving module is programmed to display the data or process it further. The data that is broadcast on the network may also include a code module that can be used by the receiving module to display the data. The data that is broadcast on the network may also include information that defines a default display format, allowing the receiving module to display the data even though the receiving module is not specifically programmed to display the specific type of data that it receives.

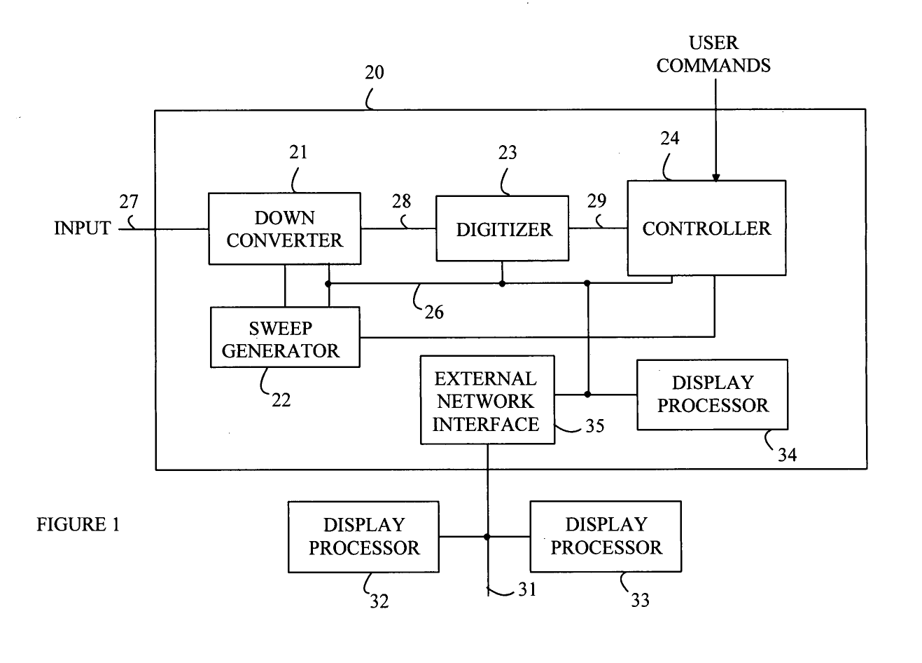

The manner in which the present invention provides its advantages can be more easily understood with reference to FIG. 1, which illustrates a spectrum analyzer utilizing a display system according to one embodiment of the present invention. Spectrum analyzer 20 is constructed from four component modules, a down converter 21, a sweep generator 22, a digitizer 23, and a controller 24. The signal path corresponds to nodes 27-29. The various component modules are also connected to an internal network 26. The down converter 21 generates an analog signal that has an amplitude related to the amplitude of the input signal at the frequency currently input to the down converter by sweep generator 22. The digitizer converts this analog signal to a digital form that is displayed by display processor 34. In addition, digitizer 23 also provides the data to controller 24 that can output the data or provide error correction or other processing. In addition, controller 24 operates the various component modules during data collection and provides a command interface for use by a user of the instrument.

In this example, either digitizer 23 or controller 24 could be a data source module that broadcasts the data on network 26. The data is displayed by a display processor 34 that is part of analyzer 20. It should be noted that if a new instrument is designed in which digitizer 23, for example, is replaced by a new type of digitizer, none of the other components need to be altered if the new digitizer broadcasts data in the same format as the old digitizer. If this condition is not met, then display processor 34 needs to be updated; however, the remaining modules can function in the same manner as those modules functioned in the old analyzer design. Hence, the present invention significantly reduces the expense and turn around time associated with providing updated versions of existing test instruments.

Analyzer 20 also includes a network interface 35 that interfaces internal network 26 to an external network 31 that could include the Internet and other forms of networks. This enables external display processors such as display processors 32 and 33 to receive the data and display the data at locations that are remote from analyzer 20. Each external display processor can display the data in a format that is customized for the users of that display processor. For example, analyzer 20 could be located in a laboratory and display processor 32 could be located in a classroom that is far from the laboratory. As measurements are made on a signal source in the laboratory, students in the classroom can view the results without any changes to analyzer 20.

Display processor 32 could utilize a default data display to simplify the initial setup of the display processor. For example, if the data source module outputs data in an HTML format, display processor 32 could use a web browser to view the data in a standard format, and hence, the external display feature can be easily implemented without altering the internal functions of analyzer 20. If more sophisticated display or data processing is desired, the default program on display processor 32 can be enhanced to provide the desired functionality. Furthermore, the display programs used by each external display processor can be different from the others. In addition, these external display processors can utilize proprietary software that is sold separately either by the manufacturer of analyzer 20 or third parties. For example, the display software could also include proprietary data processing algorithms that transform the raw data into data that is corrected for errors. Users of this more sophisticated software can be charged for the added functionality without increasing the cost of the basic analyzer.

It should be noted that the data source module could broadcast its data in a number of different formats in a series of separate transmissions. The different formats can be chosen to provide an increased range of display processors that can receive the data and display it. Hence, an upgrade in a digitizer that requires a new data format to provide additional data can be made while maintaining backward compatibility with display processors that utilize the previous data formats. In addition, the data content of the different transmissions can be different. Hence, one format could include only the basic data to be displayed. A second data transmission could include calibration data that can be utilized by a display processor to correct the data for known errors in the data source module. Hence, display processors that do not have the error correction programs would merely display the raw data while more sophisticated display processors would display the corrected data. One or more of the data formats can utilize encryption protocols to limit the use of the more detailed data to display processors that utilize proprietary software. For example, display processor 32 could utilize only a display program that displays the raw data. Data processor 33, on the other hand, could include a proprietary software package that utilizes data sent in an encrypted format to correct for known errors in the raw data prior to that data being displayed.

In addition to providing an improved method for displaying the normal output data of the instrument, an instrument according to the present invention can provide improved diagnostic functionality. In many cases, a number of modules within the instrument will be data source modules even though only one of these modules generates the data that is normally displayed on the display processor. One of the advantages of synthetic instruments is the ability to use one component module in a number of different instruments. Hence, a synthetic instrument could include a number of modules that are the generators of the displayed data in some other instruments in which those modules were utilized.

To reduce traffic on the internal network, the component modules whose data is not needed for display purposes are typically placed in a state in which those modules do not broadcast data during the normal operation of the synthetic instrument. In general, the data is broadcast during the testing phase and picked up by a display computer or other processor to assure that the instrument has been assembled correctly and does not include any defective modules. Whether or not this broadcast function is used during the normal operation of an instrument will, in general, depend on the particular synthetic instrument in which the module is utilized. However, in one embodiment of the present invention, one or more of the component modules can include a broadcast function that can be turned on or off by commands received by that module on the internal network. During the normal operation of the synthetic instrument, the data broadcast function could be utilized to provide some enhanced data display at one of the display processors or to debug an instrument that is not operating correctly, and hence, provide increased functionality at little additional cost.

Various modifications to the present invention will become apparent to those skilled in the art from the foregoing description and accompanying drawings. Accordingly, the present invention is to be limited solely by the scope of the following claims.

What is claimed is:

1. An instrument comprising:
a local area network:
a plurality of component modules, each component module having an input for receiving an input signal, an output for transferring an output signal derived from said input signal by that component module, and a network port that connects that module to said local area network, one of said component modules receiving a signal that is external to said instrument for processing on that component module's input port; and
a data source module that generates data that can be displayed, said data source module being connected to said local area network and broadcasting said data on said network, said data including information identifying said data.

2. The instrument of claim 1 further comprising a display module connected to said local area network, said display module displaying said data on a display connected to said display module.

3. The instrument of claim 1 further comprising an external network interface for coupling said local area network to a network external to said instrument, said external network interface broadcasting said data on said external network.

4. The instrument of claim 1 wherein said display module includes a default display that displays said data in a standard format that depends on said identifying information.

5. The instrument of claim 1 wherein said data source module broadcasts said data on said network in a plurality of data messages, each data message being in a different data format.

6. The instrument of claim 5 wherein said data in one of said messages is encrypted and includes data that is not in any of the others of said messages.

7. A method for displaying data generated by an instrument having a plurality of component modules, each component module having an input for receiving an input signal, an output for transferring an output signal derived from said input signal by that component module, one of said component modules receiving a signal that is external to said instrument for processing on that component module's input port, said method comprising:
providing a local area network connection for each of said component modules;
causing one of said component modules to broadcast data that can be displayed on said network, said data including information identifying said data; and
causing a display module connected to said network to display said data.

8. The method of claim 7 further comprising broadcasting said data on an external network coupled to said local area network and causing a display device on said external network to display said data.

8. The method of claim 7 wherein said display module displays said data in a standard format that depends on said identifying information.

9. The method of claim 7 wherein said data is broadcast in a plurality of data messages, each data message being in a different data format.

10. The method of claim 9 wherein said data in one of said messages is encrypted and includes data that is not in any of the others of said messages.
